(19) United States
(12) Patent Application Publication
(10) Pub. No.: US 2025/0097022 A1
(43) Pub. Date: Mar. 20, 2025

(54) Secure communication across an insecure communication channel

(71) Applicant: SAFECRET PTY LTD, Sydney, New South Wales (AU)

(72) Inventor: Anup Kattel, Leumeah (AU)

(21) Appl. No.: 18/288,801

(22) PCT Filed: May 24, 2023
(86) PCT No.: PCT/AU2023/050438

§ 371 Date: Oct. 27, 2023

Related U.S. Application Data
(63) Continuation-in-part of application No. 17/984,231, filed on Nov. 9, 2022, now Pat. No. 11,805,090.
(60) Provisional application No. 63/277,575, filed on Nov. 9, 2021.

(30) Foreign Application Priority Data
May 24, 2022 (AU) 2022901394

(51) Int. Cl. H04L 9/08

(52) U.S. Cl. CPC H04L 9/0861

(57) ABSTRACT

There is provided herein a way to communicate securely across an insecure communication channel without any involvement of a receiving party at the time of sending involving receiving message text and associated provided response text and prompt text. A cryptographic key is generated using the provided response text and the message text is encrypted using the cryptographic key to generate an encrypted message. A package comprising the encrypted message and the prompt text is transmitted across an insecure communications channel. Upon receipt of the package from the communication channel the prompt text can be loaded from the package and given response text can be received responsive to the display of the prompt text. A cryptographic key can then be generated using the given response text so that the encrypted message can be decrypted using the cryptographic key to obtain the message text.

### FIELD OF THE INVENTION

This invention relates generally to secure sending of communications across insecure communication channels, such as the Internet.

### SUMMARY OF THE DISCLOSURE

There are several methods for exchanging encryption keys over an insecure networks and public infrastructure such as the Internet.

However, these methods require active participation of the receiving party before encryption of the messages.

There is provided herein a way to communicate securely across an insecure communication channel without any involvement of a receiving party at the time of sending wherein encryption and transmission comprises receiving message text, receiving associated provided response text and prompt text and generating a cryptographic key using the provided response text.

The message text is then encrypted using the cryptographic key to generate an encrypted message and the encrypted messages transmitted in a package along with the prompt text across an insecure communications channel.

Thereafter, receipt and decryption comprises receiving the package from the communication channel and loading the prompt text from the package.

Then given response text is received responsive to the display of the prompt text. The given response text is used to generate the cryptographic key using the given response text.

The cryptographic key is used to decrypt the encrypted message using the cryptographic key to obtain the message text.

As such, no involvement is required by the recipient of the message at the time of the sending of the message.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 illustrates secure communication across an insecure communication channel;

FIG. 2 shows encryption and transmission in accordance with an embodiment; and

FIG. 3 shows receipt and decryption in accordance with an embodiment.

### DESCRIPTION OF EMBODIMENTS

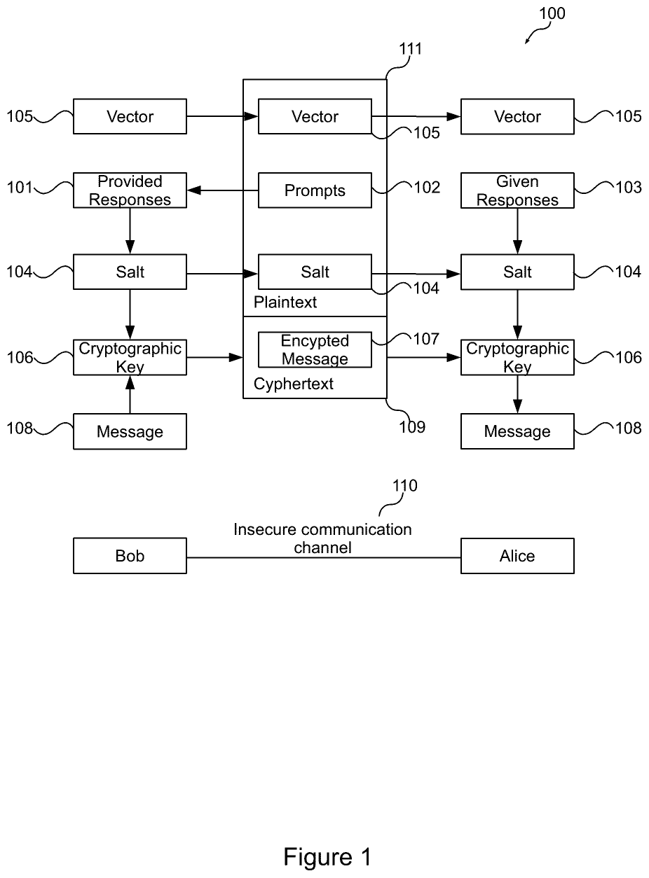

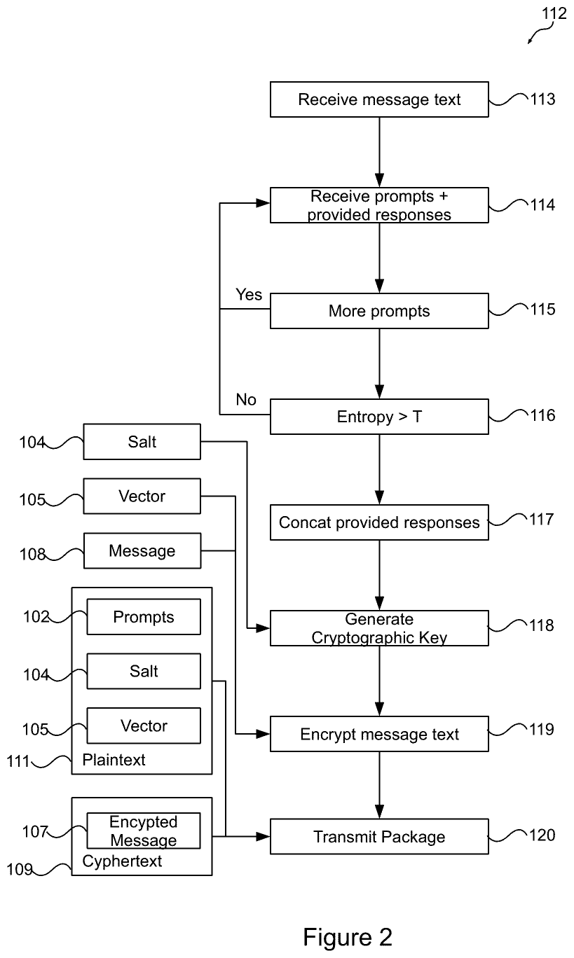

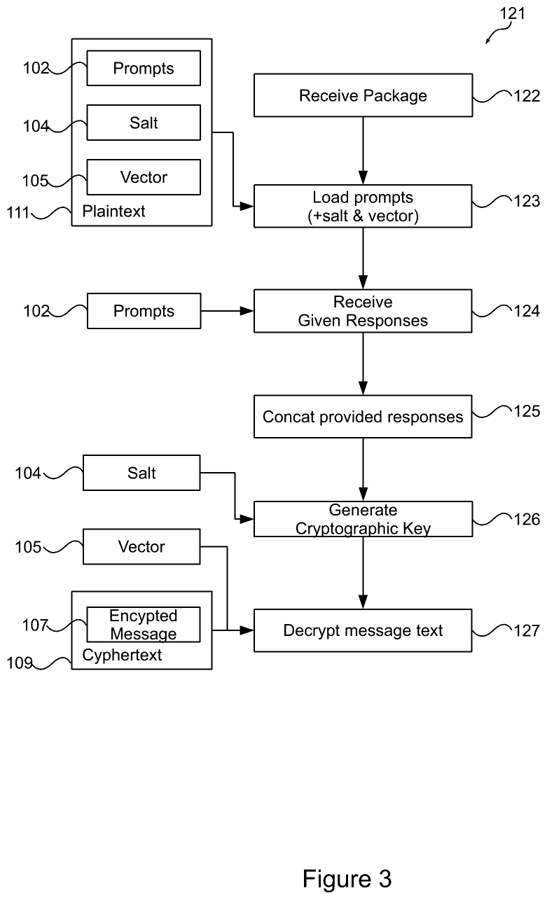

FIG. 1 illustrates Bob sending a secure message across an insecure communication channel 110 to Alice. FIG. 2 illustrates encryption and transmission 112 and FIG. 3 illustrates receipt and decryption 121.

Encryption and transmission 112 comprises receiving message text 108 at step 113. Email communication will be used herein is an example. As such, the message text 108 may comprise subject text and body text of an email message.

At step 114, provided response text 101 and associated prompt text 102 is received. In one embodiment, the provided response text 101 and associated prompt text 102 is information known or obtainable by both Bob and Alice without using the insecure communication channel 110.

In one simple example, the prompt text 102 may comprise text composed by Bob comprising “what colour car do I drive?”, with the associated provided response text 101 comprising the text “blue”. Here Bob assumes that Alice knows the answer.

In alternative embodiments as alluded to above, the response text 101 may be obtainable by Alice without using the insecure communication channel 110.

In the present example, prior sending an email, Bob's email client may prompt for at least one prompt 102 and at least one provided response 101.

In embodiments, a plurality of prompts 102 and provide responses 101 may be given. As such, at step 115, the encryption 112 may comprise prompting Bob if Bob wishes to provide more prompts 102.

In embodiments, at step 116, the encryption 112 may ensure that a minimum threshold T of entropy is met. If not, the encryption 112 may comprise repeatedly prompting Bob for prompts 102 and provide responses 101 until the threshold T is satisfied.

For example, for an entropy threshold T, c being the possible number of characters and m being the length of the provided response, all possible combinations for the entropy T=2^{T}. Further, for all possible combinations for c number of possibilities for password length of m=c^{m}. Therefore, c^{m}=2^{T}, m=log_{c}2^{T}.

For example, an entropy of 128 (T=128), using all lowercase English characters (c=26), minimum required length m=log₂₆ 2¹²⁸ (≈27.231494855 characters).

At step 117 of the encryption 112, the provided response text 101 may comprise a concatenation of provided response text strings which may be further concatenated with separators, such as commas, dashes and the like. For example, prompt text strings 102 provided by Bob may comprise “What colour is my car?”, “What country do I live in?”, “What is your daughter's name?” wherein the concatenation of provided response text strings 102 may comprise “blue, australia,sarah′.

In embodiments, the response texts may comprise lower text characters only. Alternatively, the response texts may be case sensitive and/or include special characters, numbers and the like.

At step 118, a cryptographic key 106 is generated using the provided response text 101. The cryptographic key 106 may be produced by a key derivation algorithm such as PBKDF2, bcrypt, scyrpt, Argon2id and the like.

In embodiments, encryption 112 may comprise generating salt 104 and further generating the cryptographic key 106 with the salt 104. For example, the input to the key derivation algorithm may comprise a concatenation of the provided response text 101 and the salt 104.

At step 119, the generated cryptographic key 106 is used to encrypt the message text 108 to generate ciphertext 109 comprising the encrypted message 107 at step 119.

An encryption algorithm such as AES, Triple DES, Blowfish and the like may be used to encrypt the message 108 to the encrypted message 107 using the generated cryptographic key 106.

In embodiments, encryption 112 may comprise generation of an initialisation vector 105 and wherein the encryption algorithm is initiated with the initialisation vector 105. It should be noted that, in embodiments, more than one vector 105 may be used for encryption and subsequent decryption.

At step 120, a package is transmitted across the insecure communication channel 110. As is shown in FIG. 1, the package comprises ciphertext 109 comprising the encrypted message 107 and plaintext 111 comprising the prompt text 102.

Where salt 104 is used and/or an initialisation vector 105 is used, the salt 104 and/or vector 105 may be transmitted within the package in the plaintext 111.

The receipt and decryption 121 shown in FIG. 3 comprises receipt of the package from the insecure communication channel 110 at step 122.

At step 123, the prompt text 102 is loaded from the plaintext 111.

Where the provided response text 101 comprises a concatenation of response text strings 101, step 123 may comprise loading the respective prompt text strings. In this regard, the prompt text 102 may similarly comprise a concatenation of separate prompt text strings, including those separated by a separator.

Loading the prompt text strings may comprise loading the prompt text strings in a given order which may either be transmitted with the package or alternatively obtained in sequential order from the prompt text string 102.

At step 124, the decryption 121 comprises receiving given response text 103. For example, for each prompt text string obtained from the plaintext 111, Alice's email client may display the prompts in order, each having an associated input field for receiving respective given response text strings.

At step 125, the given response text string received from Alice may similarly be concatenated in the same way as step 117 of the encryption 112.

At step 126, the given response text 103 received from Alice may be used to generate the cryptographic key 106. In embodiments, the plaintext 111 may further specify the type of key derivation algorithm and configuration/settings used to derive the cryptographic key 106.

Where salt 104 is transmitted in plaintext 111, step 123 may comprise loading the salt 104 from the plaintext 111 and using the salt 104 to generate the cryptographic key 106. Decryption 121 may comprise checking whether the package comprises salt 104 and either using the salt 104 to generate the cryptographic key or not.

At step 127, the decryption 121 comprises decrypting the encrypted message 107 using the generated cryptographic key 106.

Similarly, where the package is transmitted with the initialisation vector 105, the decryption 121 may detect the present thereof within the package, load the vector 105 and initialise the decryption algorithm using the vector 105 prior decrypting the encrypted message 107. In embodiments, the package may further specify the type of encryption algorithm and configuration/settings used to encrypt the encrypted message 107. As alluded to above, the package may be transmitted with more than one initialisation vector 105 which are detected during decryption 121 and used to initialise the decryption algorithm prior decrypting the encrypted message 107.

The decrypted message 108 is then displayed by Alice's email client.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. Secure communication across an insecure communication channel comprising:
encryption and transmission comprising:
receiving message text;
receiving associated provided response text and prompt text;
generating a cryptographic key using the provided response text;
encrypting the message text using the cryptographic key to generate an encrypted message; and
transmitting a package comprising the encrypted message and the prompt text across an insecure communications channel; and
receipt and decryption comprising:
receiving the package from the communication channel;
loading the prompt text from the package;
receiving given response text responsive to the display of the prompt text;
generating the cryptographic key using the given response text;
decrypting the encrypted message using the cryptographic key to obtain the message text.

2. Secure communication as claimed in claim 1, wherein the provided response text comprises a plurality of provided response text strings for respective prompt text strings.

3. Secure communication as claimed in claim 2, wherein the provided response text comprises a concatenation of provided response text strings.

4. Secure communication as claimed in claim 2, wherein receipt and decryption comprises:
displaying the prompt text strings in a given order;
receiving a plurality of given response text strings responsive to the display of the prompt text strings; and
concatenating the given response text strings to generate the cryptographic key.

5. Secure communication as claimed in claim 4, wherein the given order is read from the package.

6. Secure communication as claimed in claim 4, wherein the given order is a sequential order.

7. Secure communication as claimed in claim 3, wherein the concatenation comprises separators.

8. Secure communication as claimed in claim 3, further comprising receiving response text until a concatenation of the response text strings exceeds in entropy threshold.

9. Secure communication as claimed in claim 3, further comprising receiving response text until a concatenation of the response text strings exceeds a character length threshold.

10. Secure communication as claimed in claim 1, wherein encryption and transmission further comprises:
generating a salt;
generating a cryptographic key using the response texts and the salt; and
transmitting the salt across the insecure communications channel; and
wherein receipt and decryption comprises:
retrieving the salt from the package; and
generating the cryptographic key using the response texts and the salt.

11. Secure communication as claimed in claim 1, wherein encryption and transmission further comprises:
generating at least one initialisation vector;
encrypting the message text using an encryption algorithm initiated with initialisation vector; and
transmitting the vector across the insecure communications channel; and
wherein receipt and decryption comprises:
retrieving the vector from the package;
decrypting the message text using an encryption algorithm initiated with initialisation vector.
